(19) United States
(12) Patent Application Publication
(10) Pub. No.: US 2017/0091842 A1
(43) Pub. Date: Mar. 30, 2017

(54) METHODS, SYSTEMS, AND COMPUTER READABLE MEDIA FOR SELECTING A PROPOSED UTILITY RATE STRUCTURE FOR A RESIDENTIAL ELECTRIC SYSTEM

(71) Applicant: SunPower Corporation, San Jose, CA (US)

(72) Inventor: David Emerson DePuy, Los Altos Hills, CA (US)

(21) Appl. No.: 14/864,217

(22) Filed: Sep. 24, 2015

(51) Int. Cl. G06Q 30/02

(52) U.S. Cl. CPC G06Q 30/0283; G06Q 50/06

(57) ABSTRACT

Methods, systems, and computer readable media are disclosed for selecting a proposed utility rate structure for a residential electric system. In some examples, a method is performed by one or more computers and includes receiving a historic consumption time series of electric consumption measurements of a residential electric system. The method includes executing a photovoltaic simulator to computationally simulate a predicted production time series of electric production values for a photovoltaic solar system of the residential electric system. The method includes selecting, using the historic consumption time series and the predicted production time series, a proposed utility rate structure from utility rate structures for the residential electric system.

### BACKGROUND

The subject matter described in this specification relates generally to computer systems configured for selecting a proposed utility rate structure from available utility rate structures for a residential electric system.

Photovoltaic cells, commonly known as solar cells, are devices for conversion of solar radiation into electric energy. A solar panel system typically includes a panel of multiple photovoltaic cells on a frame, one or more inverters, and interconnection wiring. A solar panel system can also include other optional components such as batteries, solar trackers, and a meteorological station. The frame can be mounted on top of a building and the other components can be located on the outside or inside of the building to interface with an electric grid of the building and, in some cases, a utility electric grid. Some residential utility customers have a choice of available utility rate structures. For example, a utility customer may be able to select a utility rate structure from the available utility rate structures when contracting with the utility company.

### SUMMARY

A system of one or more computers is configured, by virtue of appropriate programming, to select a utility rate structure from a number of available utility rate structures. The system is useful, e.g., to propose a utility rate structure to a homeowner adding a photovoltaic solar system to the homeowner's residence. In some examples, the system includes one or more computers and one or more non-transitory computer readable media storing instructions that, when executed by the one or more computers, cause the one or more computers to receive a historic consumption time series of electric consumption measurements of a residential electric system. The system executes a photovoltaic simulator to computationally simulate a predicted production time series of electric production values for a photovoltaic solar system of the residential electric system. The system selects, using the historic consumption time series and the predicted production time series, a proposed utility rate structure from a plurality of utility rate structures for the residential electric system.

The subject matter described in this specification may be implemented in hardware, software, firmware, or combinations of hardware, software and/or firmware. In some examples, the subject matter described in this specification may be implemented using a non-transitory computer readable medium storing computer executable instructions that when executed by one or more processors of a computer cause the computer to perform operations.

Computer readable media suitable for implementing the subject matter described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described in this specification may be located on a single device or computing platform or may be distributed across multiple devices or computing platforms.

### BRIEF DESCRIPTION OF THE DRAWINGS

FIG. 1 is a diagram of an example residential electric system;

FIG. 2 is a block diagram illustrating an example environment of a proposal computer system configured to select a utility rate structure for a residential electric system;

FIG. 3 is a block diagram of the example proposal computer system; and

FIG. 4 is a flow diagram of an example method for selecting a proposed utility rate structure for a residential electric system.

### DETAILED DESCRIPTION

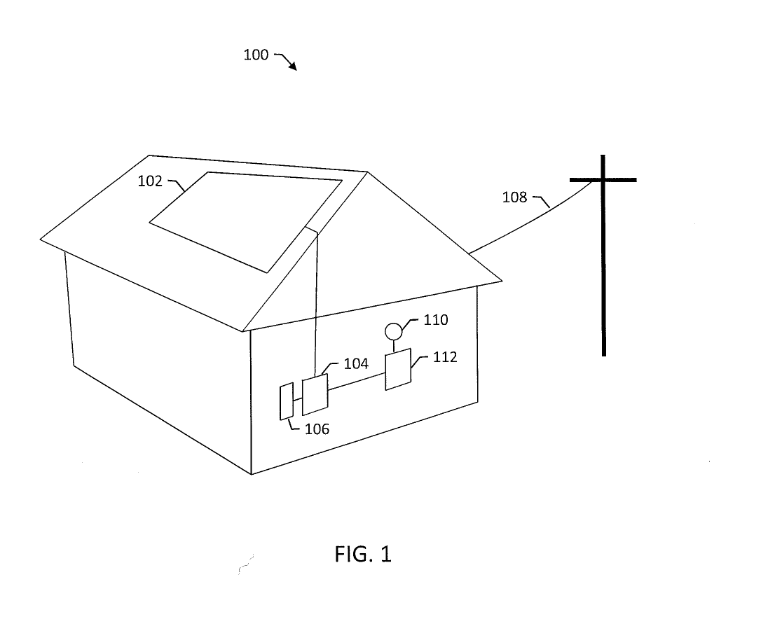

FIG. 1 is a diagram of an example residential electric system 100. The electric system 100 includes a solar panel system 102 including one or more photovoltaic solar panels, one or more inverters 104 coupled to the solar panel system 102, and a photovoltaic supervisor system 106. The electric system 100 also includes a connection 108 to a utility grid, an electric meter 110 for the connection 108 to the utility grid, and an electric panel 112 for the electric system 100. In some examples, the inverters 104 can include string inverters.

When the sun is shining on the solar panel system 102, the solar panel system 102 produces direct current (DC) electric power and provides the DC power to the inverters 104. In response, the inverters 104 produce alternating current (AC) power for consumption by loads on the electric system 100 or for providing to the connection 108 to the utility grid. When the loads on the electric system 100 consume more power than is provided by the solar panel system 102, the loads draw power from the connection 108 to the utility grid or one or more batteries. When loads consume less power than is provided by the solar panel system 102, the solar panel system 102 can provide the excess power to the connection 108 to the utility grid.

The photovoltaic supervisor system 106 is a computing system configured, by virtue of appropriate programming, to monitor the solar panel system 102 and perform one or more actions based on monitoring the solar panel system 102. For example, the photovoltaic supervisor system 106 can be configured for interfacing with net and sub meters, inverters, and other optional components of the system. In some examples, the photovoltaic supervisor system 106 measures power output by the solar panel system 102 and transmits measurements to a remote system, e.g., a homeowner's computer system, a building manager's computer system, or a remote monitoring service computer system.

When a homeowner elects to install the solar panel system 102 into the residential electric system 100, the homeowner faces a number of choices. In addition to selecting an installer and/or manufacturer of the solar panel system 102, the homeowner may need to select a physical size of the solar panel system 102 (e.g., number and dimensions of solar panels), a financing option (e.g., cash or lease), and a utility rate structure (e.g., fixed, tiered, or time of use).

A utility rate structure typically includes one or more rules that specify how electric usage will be billed to the utility. For example, in a fixed rate structure, total electric usage over a time period is multiplied by a fixed billing rate to determine the cost of the usage over that time period. In a tiered rate structure, electric usage is billed at one rate up to a certain amount and then billed at a different rate over that amount, and there may be several tiers each having a respective billing rate. In a time of use structure, electric usage can be billed based on the time of day of consumption, e.g., so that a higher billing rate applies during peak consumption hours.

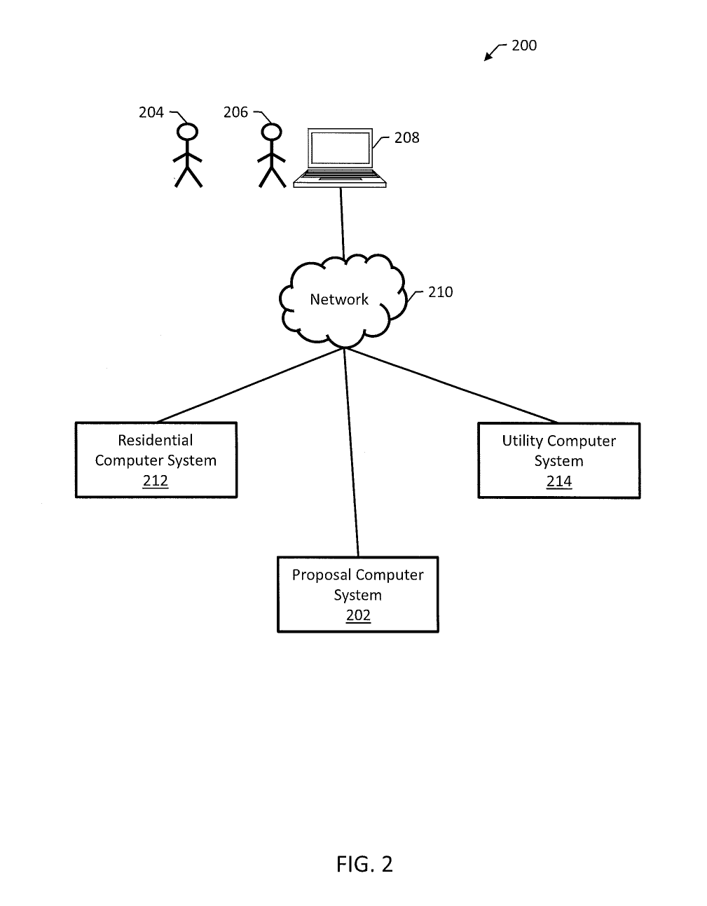

FIG. 2 is a block diagram illustrating an example environment 200 of a proposal computer system 202 configured to select a utility rate structure for a residential electric system, e.g., the residential electric system 100 of FIG. 1.

A homeowner 204 has recently installed a photovoltaic solar system or is considering having a photovoltaic solar system installed in the residential electric system and consults with an installer 206. The installer 206 uses a user device 208 to communicate with the proposal computer system 202 over a data communications network 210. The user device 208 can be a computer system with a display and a user input device, e.g., a personal computer, laptop, or tablet computer. The proposal computer system 202 can be implemented as a cloud-based service, e.g., as a server of one or more computers.

The proposal computer system 202 is configured, by virtue of appropriate programming, to import data from the user device 208, a residential computer system 212, and/or a utility computer system 214 over the data communications network 210 and to provide recommendations for presentation on the user device 208. The recommendations can include recommendations for selecting a photovoltaic system, for selecting a financing option, and for selecting a utility rate structure.

In some examples, the installer 206 executes a web browser on the user device 208 and enters a uniform resource locator (URL) into the web browser for the proposal computer system 202. The proposal computer system 202 executes a web server that provides a graphical user interface (GUI) to the user device 208, e.g., as one or more web pages which can be comprised of, e.g., hypertext markup language (HTML) files and image files. The installer 206 can then supply data to the proposal computer system 202 using the GUI, and the proposal computer system 202 can provide recommendations, e.g., on one or more display screens of the GUI, which is displayed on the user device 208.

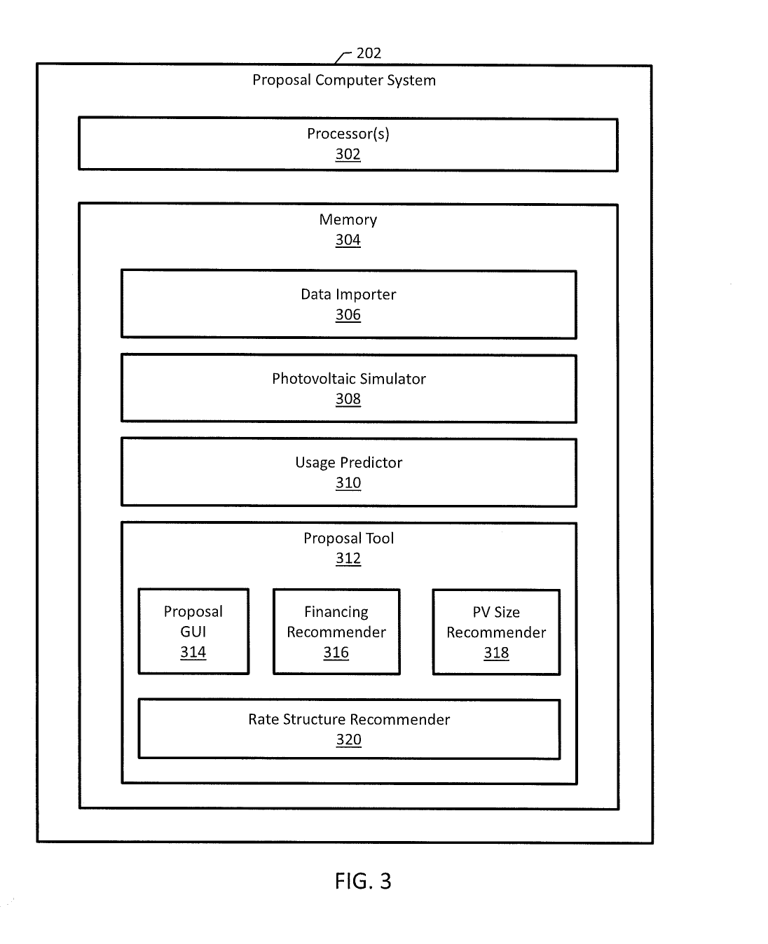

FIG. 3 is a block diagram of the example proposal computer system 202. The proposal computer system 202 includes one or more processors 302 and memory 304 storing instructions for execution by the processors 302 and other data. For example, the proposal computer system 202 can load the instructions into random access memory (RAM) for execution by the one or more processors 302.

The proposal computer system 202 includes a data importer 306 for receiving data for determining recommendations. The data importer 306 can be configured to receive a historic consumption time series of electric consumption measurements of a residential electric system. For example, suppose that the utility computer system 214 maintains a time series of electric consumption measurements, e.g., made by the electric meter 110 of FIG. 1. The homeowner can supply login credentials to the utility computer system 214 to access the homeowner's account on the utility computer system 214, download the time series, and then supply the time series to the installer 206, e.g., on a disk or by email.

The installer 206 can then supply the time series to the proposal computer system 202 using the user device 208 by sending the time series over the data communications network 210. The proposal computer system 202 can alternatively receive the time series directly from the utility computer system 214 or from the residential computer system 212. The residential computer system 212 may have the time series by virtue of monitoring the residential electric system or by receiving the time series from the utility computer system 214.

The data importer 306 can also receive information from the user device 208 regarding the homeowner's existing residential electric system. For example, the installer 206 can supply, using the user device 208, the postal address of the residential electric system and data characterizing a proposed photovoltaic solar system, e.g., the size, photovoltaic efficiency, orientation, and inverter characteristics of the photovoltaic solar system. In some examples, the installer 206 indicates which utility rate structures are available for the residential electric system; in some other examples, the proposal computer system 202 determines which utility rate structures are available for the residential electric system using the postal address, e.g., by querying the utility computer system 214 using a application programming interface (API) of the utility computer system 214. The available utility rate structures can include currently available utility rate structures and future utility rate structures that will or may become available in the future.

The proposal computer system 202 includes access to a photovoltaic simulator 308 for computationally simulating a predicted production time series of electric production values for a photovoltaic solar system that is either already part of the residential electric system or is being planned for the residential electric system. The photovoltaic simulator 308 can use, in the simulation, the size, photovoltaic efficiency, orientation, and inverter characteristics of the photovoltaic solar system. The photovoltaic simulator 308 can also use historic weather data and any other appropriate data to computationally simulate the predicted production of the photovoltaic solar system.

The proposal computer system 202 includes a usage predictor 310 for predicted electric usage for a future time period. The usage predictor 310 predicts electric usage based on the historic consumption time series imported by the data importer 306 and, in some cases, data characterizing one or more expected consumption changes. For example, for a future time of 10:00 AM on a Tuesday, the usage predictor 310 can use one of the values from the historic consumption time series that corresponds to 10:00 AM on a Tuesday, or a value closest to that time, or an average value of times that correspond to 10:00 AM or Tuesday or both.

The data characterizing the expected consumption changes can include data characterizing a life event, e.g., a child leaving for college and a corresponding expected decrease in usage; an electric vehicle consumption profile for an electric vehicle the homeowner has recently purchased or is planning on purchasing; a battery system consumption profile for a battery system the homeowner has recently purchased or is planning on purchasing; and an electric residential appliance consumption profile for an appliance the homeowner has recently purchased or is planning on purchasing, e.g., a high efficiency washer or a hot tub. The data importer 306 can receive the data, e.g., from the installer 206 supplying the data using the user device 208.

The proposal computer system 202 includes a proposal tool 312 for determining recommendations related to installation of a photovoltaic solar system in the residential electric system. The proposal tool 312 includes a proposal graphical user interface (GUI) 314, a financing recommender 316, a photovoltaic size recommender 318, and a rate structure recommender 320. The GUI 314 can be implemented using any appropriate user interface technology, e.g., one or more web pages transmitted to the user device 208.

The financing recommender 316 is configured to select a proposed financing option from available financing options for purchasing and/or installing a photovoltaic solar system at the residential electric system and presenting, e.g., using the GUI 314, the proposed financing option. The available financing options can include, e.g., cash, loan, power purchase agreement (PPA), or lease. The financing recommender 316 can select the proposed financing option based on, e.g., one or more interest rates, the historic time series consumption data, the predicted production for the photovoltaic simulator 308, and any other appropriate data.

The photovoltaic size recommender 318 is configured to determine a proposed size of the photovoltaic solar system. The photovoltaic size recommender 318 can compute a predicted usage expense with several different sizes of photovoltaic solar systems, e.g., different numbers and/or sizes of panels, and then recommend the size resulting in the best return on investment (ROI), or net present value (NPV). For example, if a homeowner is subject to a tiered rate structure, the photovoltaic size recommender 318 can determine a size needed to prevent the net consumption of the residential electric system from exceeding a threshold that triggers a higher billing rate. The recommended size can be specified using any appropriate metric, e.g., by physical dimensions, Kilo-Watt rating, Kilo-Watt-Hour production, or any appropriate measure of energy production.

The rate structure recommender 320 is configured to determine a proposed utility rate structure. The rate structure recommender 320 can use the photovoltaic simulator 308 and the usage predictor 310 to determine a predicted usage expense for each available utility rate structure. Then, the rate structure recommender 320 selects, as the proposed utility rate structure, the available utility rate structure having the lowest predicate usage expense of the available utility rate structures.

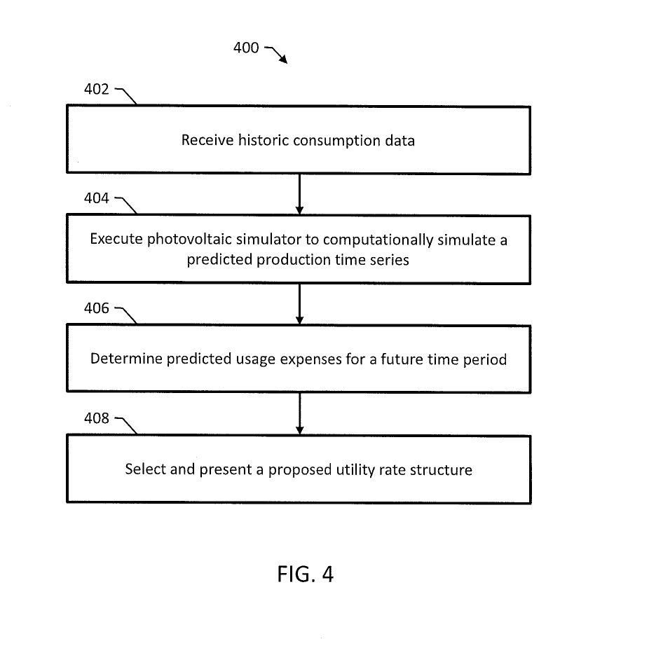

FIG. 4 is a flow diagram of an example method 400 for selecting a proposed utility rate structure for a residential electric system that has a photovoltaic solar system or may have a photovoltaic solar system installed in the future. The method 400 is performed by a system of one or more computers. The proposed utility rate structure can be presented to a homeowner, e.g., on a display of a user device, which then causes the homeowner to select the proposed utility rate structure, e.g., by submitting the selection a utility computer system.

The system receives a historic consumption time series of electric consumption measurements of a residential electric system (402). For example, the homeowner may have data for the historic consumption time series stored on a residential computer system, e.g., the residential computer system 212 of FIG. 2, or a utility computer system, e.g., the utility computer system 214 of FIG. 2. The system can receive the data from one of those systems or from an intermediate system such as the user device 208 of FIG. 2.

The system can receive other data characterizing the residential electric system and/or the photovoltaic solar system. For example, the system can receive data characterizing the size and photovoltaic efficiency of the photovoltaic solar system. The system can receive data characterizing the geographic location and orientation of the photovoltaic solar system. The system can receive data characterizing electric properties of any inverters used or planned to be used in the photovoltaic solar system.

The system can determine the available utility rate structures for the residential electric system using one or more elements of a postal address for the residential electric system, and the system can receive the postal address from a user device controlled by the homeowner or an installer. In some examples, the system receives data specifying a future utility rate structure and/or a rate structure update. For example, where a utility company applies for a rate structure update through a public utilities commission or other public entity, the system can receive data characterizing the rate structure update at the time of the application or at the time that the application is approved but not yet in effect. The system can use the rate structure update in determining a predicted usage expense for the residential electric system.

The system executes a photovoltaic simulator to computationally simulate a predicted production time series of electric production values for a photovoltaic solar system of the residential electric system (404). For example, executing the photovoltaic simulator can include simulating photovoltaic electric production using a geographic location and an orientation of the photovoltaic solar system and data characterizing the photovoltaic efficiency of the photovoltaic solar system. The system can determine the geographic location of the photovoltaic solar system using a postal or geocoded address for the residential electric system.

The system determines, for each available utility rate structure, a predicted usage expense for a future time period (406). The predicted usage expenses are based on one or more billing rules of the available utility rate structure, the historic consumption time series, and the predicted production time series. For example, the system can determine, for each future time in the future time period, a predicted net consumption value by subtracting a predicted production value from a predicted usage value. Since billing rules may vary based on, e.g., seasons and days of the week, the system can used the billing rules of the available utility rate structure to determine the appropriate billing rate that applies for each future time period.

The predicted production value is based on the predicted production time series, e.g., the predicted production value can be equal to the value from the predicted production time series corresponding to the future time. The predicted usage value is based on the historic consumption time series. For example, if the future time is 10:00 AM on a Tuesday, the system can use one of the values from the historic consumption time series that corresponds to 10:00 AM on a Tuesday, or a value closest to that time, or an average value of times that correspond to 10:00 AM or Tuesday or both.

In some examples, the system receives data specifying an expected consumption change to the historic consumption time series for the residential electric system. The system can use that data to determine the predicted usage value, e.g., by modifying a value from the historic consumption time series using the data specifying the expected consumption change. The data can include data characterizing a life event, e.g., a child leaving for college and a corresponding expected decrease in usage; an electric vehicle consumption profile for an electric vehicle the homeowner has recently purchased or is planning on purchasing; a battery system consumption profile for a battery system the homeowner has recently purchased or is planning on purchasing; and an electric residential appliance consumption profile for an appliance the homeowner has recently purchased or is planning on purchasing, e.g., a high efficiency washer or a hot tub.

The system then determines, for each future time, a predicted charge for the future time based on the predicted net consumption and a billing rate for the future time, e.g., by multiplying the predicted net consumption and the billing rate. The billing rate is based on the one or more billing rules of the utility rate structure. The system sums the predicted charges and makes any other appropriate adjustments to determine the predicted usage expense.

The system selects, using the historic consumption time series and the predicted production time series, a proposed utility rate structure from the available utility rate structures for the residential electric system (408). For example, the system can select the available utility rate structure having the lowest predicted usage expense of the available utility rate structures. The system presents the proposed utility rate structure, e.g., by sending a text string describing the proposed utility rate structure to a user device for presentation on a display of the user device to an installer and/or a homeowner.

The system can present the proposed utility rate structure as part of one or more display screens of a photovoltaic solar system proposal tool or paper displays printed from the photovoltaic solar system proposal tool by a printer. For example, the system can receive data specifying financing options for a photovoltaic solar system and select and present a proposed financing option with the proposed rate structure. In another example, the system can present a recommended physical size of the photovoltaic solar system based on the historic consumption time series and the proposed utility rate structure.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method performed by a system of one or more computers, the method comprising:
receiving, by the system of one or more computers, a historic consumption time series of electric consumption measurements of a residential electric system;
executing, by the system of one or more computers, a photovoltaic simulator to computationally simulate a predicted production time series of electric production values for a photovoltaic solar system of the residential electric system; and
selecting, by the system of one or more computers using the historic consumption time series and the predicted production time series, a proposed utility rate structure from a plurality of utility rate structures for the residential electric system.

2. The method of claim 1, wherein selecting the proposed utility rate structure comprises:
determining, for each available utility rate structure, a predicted usage expense for a future time period based on one or more billing rules of the available utility rate structure, the historic consumption time series, and the predicted production time series; and
selecting, as the proposed utility rate structure, the available utility rate structure having the lowest predicted usage expense of the available utility rate structures.

3. The method of claim 2, wherein determining, for each available utility rate structure, a predicted usage expense comprises:
determining, for each future time in a plurality of future times, a predicted net consumption value by subtracting a predicted production value from a predicted usage value, wherein the predicted production value is based on the predicted production time series and the predicted usage value is based on the historic consumption time series;
determining, for each future time, a predicted charge for the future time based on the predicted net consumption and a billing rate for the future time, wherein the billing rate is based on the one or more billing rules of the utility rate structure; and
summing the predicted charges to determine the predicted usage expense.

4. The method of claim 1, comprising:
receiving data specifying an expected consumption change to the historic consumption time series for the residential electric system or a rate structure update;
wherein selecting the proposed utility rate structure comprises determining a predicted usage expense for the residential electric system using the historic consumption time series and the expected consumption change or rate structure update or both.

5. The method of claim 4, wherein receiving data specifying an expected consumption change comprises receiving one or more of: data characterizing a life event, an electric vehicle consumption profile, a battery system consumption profile, and an electric residential appliance consumption profile.

6. The method of claim 1, comprising determining the available utility rate structures for the residential electric system using one or more elements of a postal address for the residential electric system.

7. The method of claim 1, wherein executing the photovoltaic simulator comprises simulating photovoltaic electric production using a geographic location and an orientation of the photovoltaic solar system and data characterizing a photovoltaic efficiency of the photovoltaic solar system.

8. The method of claim 1, wherein receiving the historic consumption time series comprises receiving the historic consumption time series from a residential metering system of the residential electric system or from a utility metering computer system remote from the residential electric system.

9. The method of claim 1, comprising:
receiving data specifying a plurality of financing options for purchasing and/or installing the photovoltaic solar system at the residential electric system;
selecting a proposed financing option from the plurality of financing options; and
presenting, in one or more display screens of a photovoltaic proposal tool, the proposed financing option and the proposed utility rate structure.

10. The method of claim 9, comprising presenting, in one of the one or more display screens of the photovoltaic proposal tool, a recommended physical size of the photovoltaic solar system based on the historic consumption time series and the proposed utility rate structure, thereby causing a consumer to have the photovoltaic solar system installed at the residential electric system at the recommended physical size.

11. A system comprising:
one or more computers;
one or more non-transitory computer readable media storing instructions that, when executed by the one or more computers, cause the one or more computers to perform operations comprising:
receiving a historic consumption time series of electric consumption measurements of a residential electric system;
executing a photovoltaic simulator to computationally simulate a predicted production time series of electric production values for a photovoltaic solar system of the residential electric system; and
selecting, using the historic consumption time series and the predicted production time series, a proposed utility rate structure from a plurality of utility rate structures for the residential electric system.

12. The system of claim 11, wherein selecting the proposed utility rate structure comprises:
determining, for each available utility rate structure, a predicted usage expense for a future time period based on one or more billing rules of the available utility rate structure, the historic consumption time series, and the predicted production time series; and
selecting, as the proposed utility rate structure, the available utility rate structure having the lowest predicted usage expense of the available utility rate structures.

13. The system of claim 12, wherein determining, for each available utility rate structure, a predicted usage expense comprises:
determining, for each future time in a plurality of future times, a predicted net consumption value by subtracting a predicted production value from a predicted usage value, wherein the predicted production value is based on the predicted production time series and the predicted usage value is based on the historic consumption time series;
determining, for each future time, a predicted charge for the future time based on the predicted net consumption and a billing rate for the future time, wherein the billing rate is based on the one or more billing rules of the utility rate structure; and
summing the predicted charges to determine the predicted usage expense.

14. The system of claim 11, the operations comprising:
receiving data specifying an expected consumption change to the historic consumption time series for the residential electric system or rate structure update;
wherein selecting the proposed utility rate structure comprises determining a predicted usage expense for the residential electric system using the historic consumption time series and the expected consumption change or rate structure update or both.

15. The system of claim 14, wherein receiving data specifying an expected consumption change comprises receiving one or more of: data characterizing a life event, an electric vehicle consumption profile, a battery system consumption profile, and an electric residential appliance consumption profile.

16. The system of claim 11, the operations comprising determining the available utility rate structures for the residential electric system using one or more elements of a postal address for the residential electric system.

17. The system of claim 11, wherein executing the photovoltaic simulator comprises simulating photovoltaic electric production using a geographic location and an orientation of the photovoltaic solar system and data characterizing a photovoltaic efficiency of the photovoltaic solar system.

18. The system of claim 11, wherein receiving the historic consumption time series comprises receiving the historic consumption time series from a residential metering system of the residential electric system or from a utility metering computer system remote from the residential electric system.

19. The system of claim 11, the operations comprising:
receiving data specifying a plurality of financing options for purchasing and/or installing the photovoltaic solar system at the residential electric system;
selecting a proposed financing option from the plurality of financing options; and
presenting, in one or more display screens of a photovoltaic proposal tool, the proposed financing option, the proposed utility rate structure, a recommended physical size of the photovoltaic solar system based on the historic consumption time series and the proposed utility rate structure, thereby causing a consumer to have the photovoltaic solar system installed at the residential electric system at the recommended physical size.

20. One or more non-transitory computer readable media storing executable instructions for a system of one or more computers, wherein the instructions, when executed by the one or more computers, cause the one or more computers to perform operations comprising:
receiving a historic consumption time series of electric consumption measurements of a residential electric system;
executing a photovoltaic simulator to computationally simulate a predicted production time series of electric production values for a photovoltaic solar system of the residential electric system; and
selecting, using the historic consumption time series and the predicted production time series, a proposed utility rate structure from a plurality of utility rate structures for the residential electric system.
